(19) United States
(12) Patent Application Publication
(10) Pub. No.: US 2005/0004924 A1
(43) Pub. Date: Jan. 6, 2005

(54) Control of access to databases

(76) Inventor: Adrian Baldwin, Bristol (GB)

Correspondence Address: HEWLETT-PACKARD COMPANY;Intellectual Property Administration, P.O.Box 272400, Fort Collins, CO, 80527-2400, US

(21) Appl. No.: 10/832,954

(22) Filed: Apr. 27, 2004

(30) Foreign Application Priority Data
Apr. 29, 2003 (GB) 0309849.8

(51) Int. Cl. G06F 7/00

(52) U.S. Cl. 707/100

(57) ABSTRACT

A database system comprises an encrypted index; and a secure component capable of manipulating said encrypted index.

### FIELD OF THE INVENTION

The present invention relates to method and apparatus for controlling access to databases.

### BACKGROUND TO THE INVENTION

Security in prior art database systems is a much-studied field. In some known databases, security of access is achieved by restricting permissions of individual authorized users of the database. This may be achieved by passwords and levels of authorization assigned to passwords.

Known database systems have tree based indexes which are used to locate data during queries and searches of the database.

Referring to FIG. 1 herein, there is illustrated schematically a known database system. The database system comprises a database 100, which may comprise a plurality of known server computers having data storage devices; and a database management system 101, comprising an application program resident on one or more server computers. A user 102 queries the database using the database management system and may receive back a set of tables 103.

A query takes the form of an index identifier, and an index value, [index; value] and there may be a range of values within the query.

Referring to FIG. 2 herein, there is illustrated schematically a known database primary index comprising a structure similar to a b-tree structure. The index is structured as a hierarchical tree structure with large node sizes designed to minimize the number interactions with a data storage disk of a computer device hosting a database.

The tree comprises a root node 200 having a key comprising a number of data block numbers and a set of pointers pointing to individual sets of data blocks; and a set of leaf nodes 201 which contain a set of memory values for individual blocks of data. Between the root node and the plurality of leaf nodes, are a plurality of intermediate nodes 202 which contain keys and pointers. There may be several layers of intermediate nodes between the root node and the plurality of leaf nodes. The nodes typically have a size of a disk block (or multiple blocks) with a maximum of 2t−1 keys and 2 t pointers to lower tree nodes, with a minimum of t−1 nodes in a block.

To find a data item, the tree is traversed by reading a block and performing a linear search to find a position of a search key within the block. If the data item is found, a pointer to the data item associated with a search key is returned. Otherwise, if the node is a leaf node, and the data item is not found, a ‘not found value’ can be returned, or the next layer down in the tree can be explored by the database management system.

Traditional database security approaches are concerned with securing a perimeter around a database, and developing access control models to limit who can run a query on a database. Where data is encrypted, the encryption keys are either managed outside of the system, thereby removing the ability to index particular fields, or file level encryption is used with a centrally managed key that is available within a database system.

Trusted database systems are known, for example in WO 01/06374 ‘Trusted Storage Systems and Methods’, based upon a small amount of trusted data storage. In that disclosure, access to a database is available through a trusted application. However there is no specific disclosure of how to protect a database, itself or a specific mechanism for ensuring that the database itself is inherently secure.

Other prior art disclosures use secure hardware to search encrypted files. However, these are flat file structures where the complete file is streamed through a hardware system during search.

### SUMMARY OF THE INVENTION

Specific embodiments disclosed herein provide a method for encrypting and integrity checking a tree structure by splitting tree traversal between a conventional server and a trusted secure hardware component which performs key management and access control. This strengthens control on who can access a data structure, thereby preventing human administrators from accessing data and performing searches. This approach is in contrast with traditional perimeter based security approaches.

Specific embodiments herein are concerned with pushing the security aspects into basic indexing algorithms, and coupled with a use of a trusted computing module, such as a secure hardware device, raises the standard of security and key management.

According to a first aspect, there is provided database system comprising: an unsecure database residing on a host computer; said database capable of storing unencrypted data records; an encrypted index of said data records; and a secure component capable of manipulating said encrypted index.

According to a second aspect, there is provided a database comprising: an unsecure data storage area, capable of storing a plurality of unencrypted data records; and an encrypted index for indexing said data records stored in said unsecure data storage area.

According to a third aspect, there is provided a database system comprising: a data storage area capable of storing a plurality of data records; an encrypted index for indexing said plurality of data records stored in said unsecure data storage area; a secure hardware component capable of managing a database session on behalf of at least one user; and a query management component capable of performing database query operations within a said search session.

According to a fourth aspect, there is provided a secure hardware component capable of searching an encrypted database index, said component comprising: a secure tamper proof casing containing: an index manipulation component, capable of modifying said encrypted database index.

According to a fifth aspect there is provided a method of searching an encrypted index by an index manipulating component, said method comprising: the index manipulating component receiving a search query from a user containing an index to be searched, a key to be searched for and information identifying the user; the index manipulating component requesting encrypted information in one or more nodes of the index in accordance with the search query; the index manipulating component decrypting the encrypted information and requesting further encrypted information as necessary to obtain such information as is necessary to answer the search query; and the index manipulating component causing information necessary to answer the search query to be encrypted with at least a part of the information identifying the user and sent to the user.

According to a sixth aspect there is provided a means for searching an encrypted index, comprising: means for receiving a search query from a user, said search query containing an index to be searched, the key to be searched for, and information identifying said user; means for requesting encrypted information in one or more nodes of the index in accordance with the search query; means for decrypting the encrypted information and requesting further encrypted information as necessary to obtain such information as is necessary to answer the search query; and means for encrypting information necessary to answer said search query, said means for encrypting being operable for encrypting said information with at least a part of the information identifying the user.

According to a seventh aspect there is provided a database system comprising: a host computer, hosting a database; an encrypted index comprising a plurality of data blocks arranged in a tree structure, each said data block being individually encrypted; a secure component capable of manipulating said encrypted index, said secure component comprising: a key manager component for storing a set of keys; a session manager component for managing a user session of said database; a policy engine component for applying at least one policy for usage of said database; and a tamper detection component for detecting tampering of said secure hardware component.

According to an eighth aspect there is provided a secure hardware component capable of searching an encrypted database index, said component comprising: a secure tamper proof casing containing: an index manipulation component, capable of searching an encrypted database index; a key manager component for storing a set of keys; a session management component for managing a user session for using said database; and a policy engine component for applying at least one policy concerning using said database.

According to a ninth aspect there is provided an index manipulation component for manipulating an encrypted index of a database, said index manipulation component comprising: a computer entity capable of operating in accordance with a set of algorithms, for manipulation of said index; said set of algorithms comprising: a node splitting algorithm for splitting at least one node of said index; a node encryption algorithm for encrypting at least one node of said index; a node decryption algorithm for decrypting at least one node of said index; and a pointer insert algorithm for inserting a pointer in said index.

According to a tenth aspect there is provided a An encrypted b-tree index, comprising: a plurality of nodes, each said node being encrypted, and sealed with a message authentication code (MAC).

Other aspects will become apparent as disclosed in the description herein.

### BRIEF DESCRIPTION OF THE DRAWINGS

For a better understanding of the invention and to show how the same may be carried into effect, there will now be described by way of example only, specific embodiments, methods and with reference to the accompanying drawings in which:

FIG. 1 illustrates schematically a database system applying known access control methods;

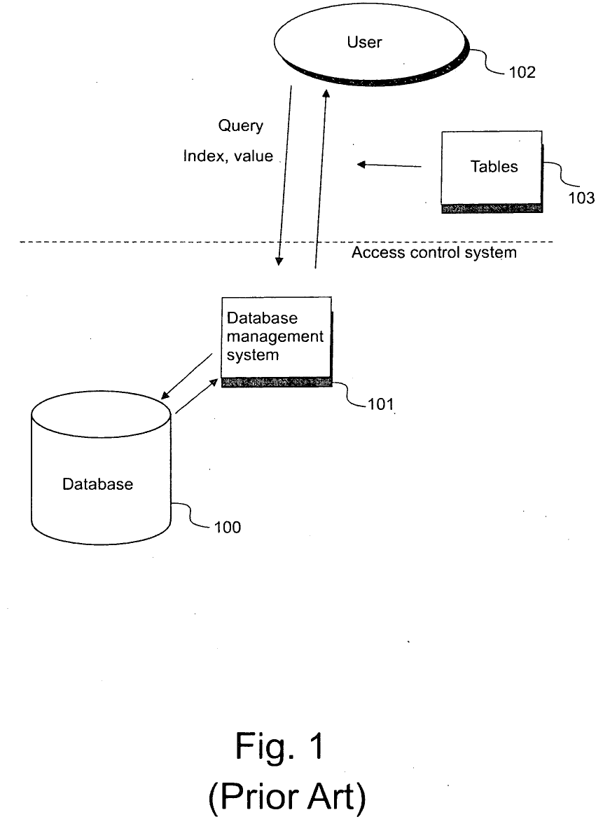

FIG. 2 illustrates schematically a know B-tree database index having a root node, a plurality of leaf nodes, and one or a plurality of intermediate nodes, in an hierarchical tree structure.

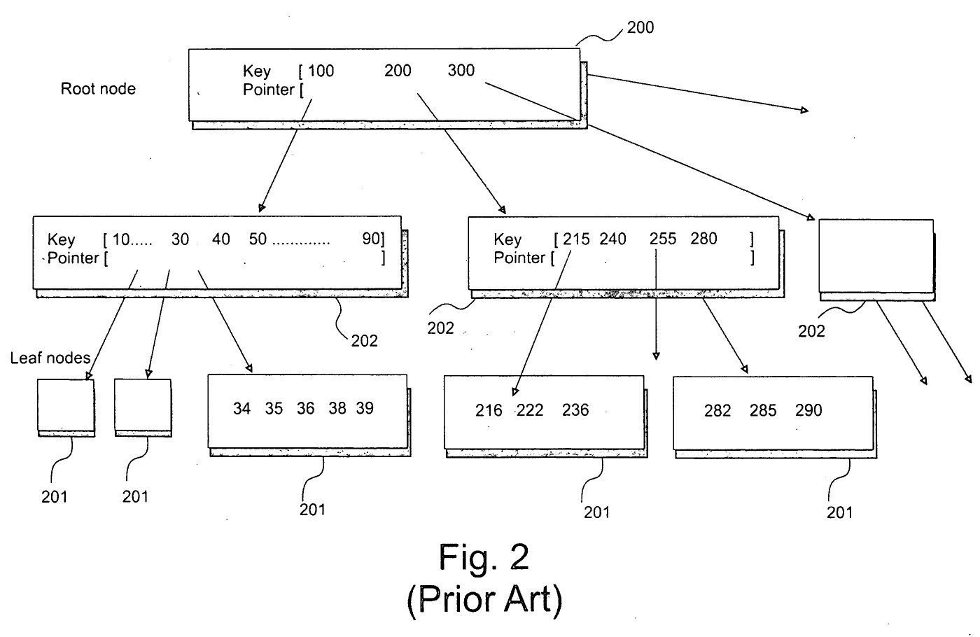

FIG. 3 illustrates schematically a first specific embodiment of a secure database management system;

FIG. 4 illustrates schematically components of a secure hardware device comprising the secure database management system of FIG. 3;

FIG. 5 illustrates schematically a specific method of operation of the secure hardware device of FIG. 4 for verifying authorization of a user;

FIG. 6 illustrates schematically process steps carried out by the secure hardware device for allowing commencement of a search session of a database;

FIG. 7 illustrates schematically communications between a secure hardware device, a database server, and a user, when performing a search session; and

FIG. 8 illustrates schematically an architecture of an encrypted index tree comprising the secure database system of FIG. 3;

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

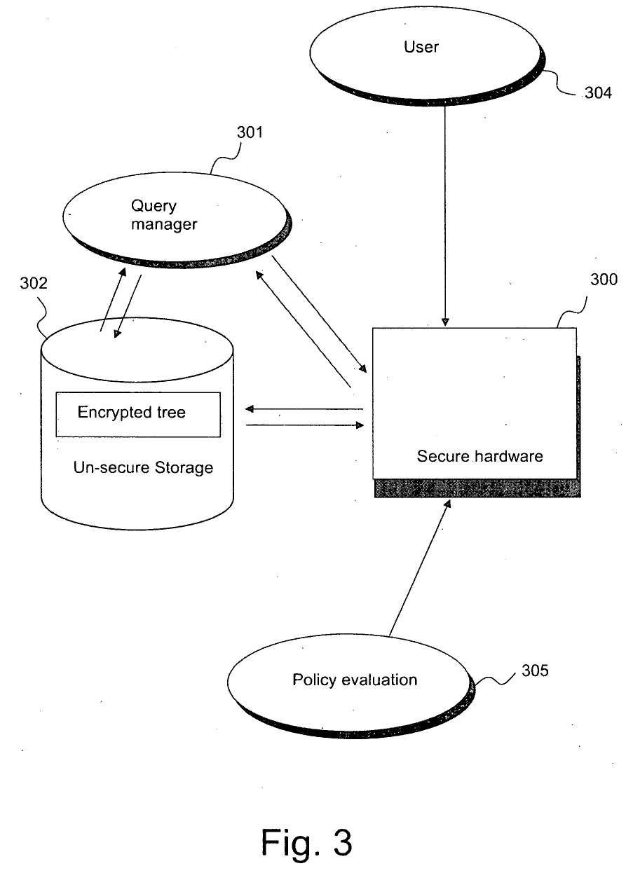

Referring to FIG. 3 herein, there is illustrated schematically components of a secure database management system according to a specific embodiment. The secure database management system comprises a secure hardware device 300; a query management system 301; a database 302 having an encrypted index tree 303. The secure hardware device 300 applies and enforces policies for access to the database by a plurality of users 304. Policies contained within the secure hardware device can be managed and changed remotely by authorized users from one or more administrator computer entities, shown schematically in FIG. 3 as a logical entity, policy evaluation 305.

The specific embodiment of FIG. 3 herein is concerned with encrypting a tree structure such that only authorised searches can be performed. Secure hardware device 300 is used to encrypt and decrypt a plurality of b-tree nodes, and to perform simple in-memory operations, such as a linear search, key and pointer inserts, and node splitting. Algorithms for carrying out these operations are relatively simple.

A database server hosts the database, and deals with disk access, and operations such as fetching and storing modified b-tree blocks to disk. In this way, it is ensured that the content of each b-tree node is only viewed within a trusted environment.

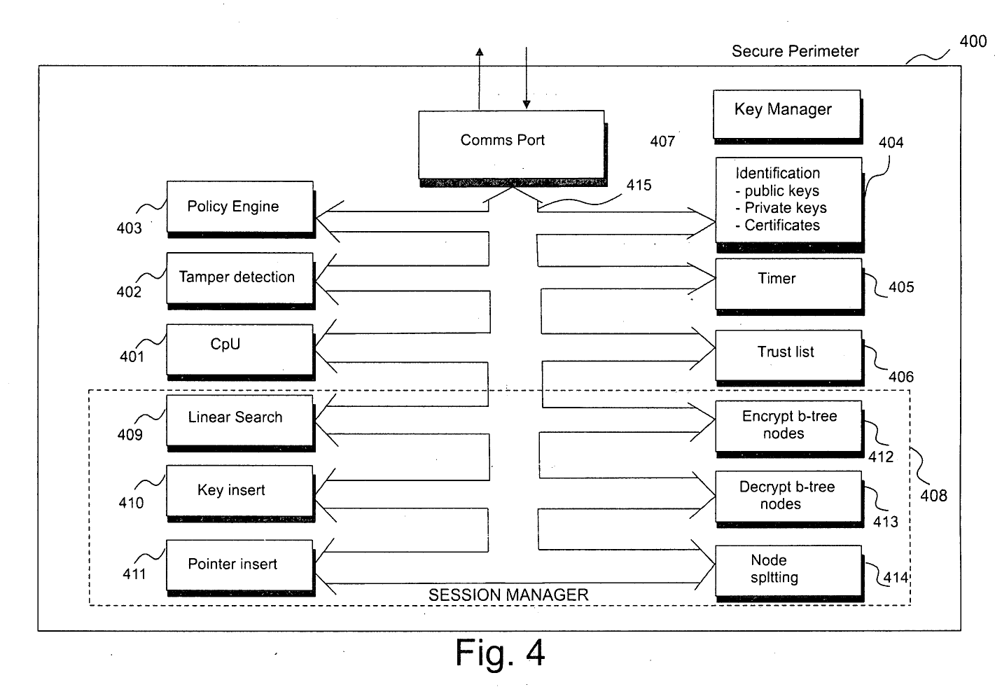

Referring to FIG. 4 herein, there is illustrated schematically a secure hardware device. The secure hardware device comprises a secure tamper proof casing 400 containing a power supply unit; a central processing unit 401 in the form of a known data processor device; a tamper detection component 402 for detecting whether the device has been tampered with; a policy engine 403 for enforcing data control policies for accessing data; a key manager identity module 404 comprising means for generating one or a plurality of private keys, and means for generating one or a plurality of public keys and a digital certificate identifying the secure hardware device; a secure timer device 405 capable of maintaining a device time; a trust list 406 comprising a list of pre-stored addresses of trusted computer entities with which the device can communicate; a communications port 407 for communicating with external computer entities; and a database management component 408, the database management component comprising a linear search algorithm 409 for performing linear searches on nodes of a database index; a key insert component 410 for inserting an index key into an index node; a pointer insert component 411 for inserting an index pointer into an index node; an index node encryption component 412 for encrypting a node of an index tree; an index node decryption component 413 for decrypting a node of an index tree; and a node splitting component 414 for splitting an index node; and a data bus 415, for connecting the above mentioned components of the secure hardware device to communicate with each other.

Operation of the secure database management system of FIG. 3 will now be described.

Overview

Database 302 comprises an unsecure data storage area for storing large volumes of data, and an encrypted index 303. In order to access data from the database, a user 304 makes a request to the secure hardware device 300. The secure hardware device controls access to data in the database according to a set of pre-stored policies and authorizations.

Fulfillment of the user request may be made in combination by the query manager 301; and the secure hardware device 300.

A user of the system carries out a session, in which the user enters an original search request and in return receives from the system, a result relating to the original search request.

Session

A session starts with a query, which is possibly encrypted, which is sent to the secure hardware device. The secure hardware device has its own distinct identity. The query has the form of the index being searched, and identifies the key being searched for, and identity information about the requester of the search, including some credentials of the requester. For example the credentials could identify the requester as a doctor. This information is used in conjunction with an access control policy to check that the requester search is valid. For example, the access control policy may allow a doctor to search for any patient, or for patients to search only for entries relating to themselves. Once a policy check has been made, a search session is created, and can proceed based on a session token.

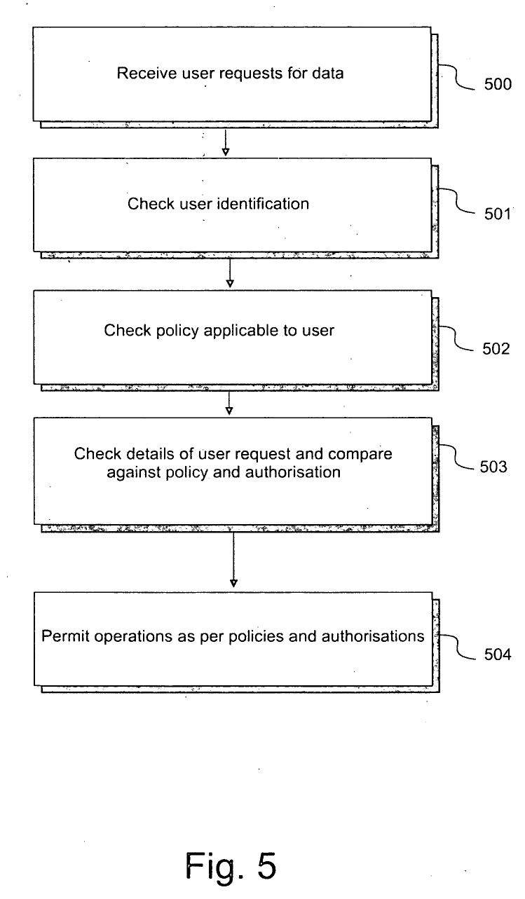

Referring to FIG. 5 herein, there is illustrated schematically processes carried out by secure hardware device 300 upon receiving a request from a user 304. In process 500, the secure hardware device receives a request for access or storage of data from the user. The request may take the form of a request to search, a request to deliver data, or a request to store data. In process 501, the secure hardware device checks the identification of the user. In process 502, the secure hardware device checks a set of internal policy data, to see what polices are applicable to the identified user. In process 503, the secure hardware device checks the details of the user request, and compares the operations requested in the request against the internally stored policies of the secure hardware device, and the authorization level of that particular user. Provided that the request falls within the scope of the authorization and policies applicable to that user, then in process 504, the secure hardware device permits the operation, subject of the users request.

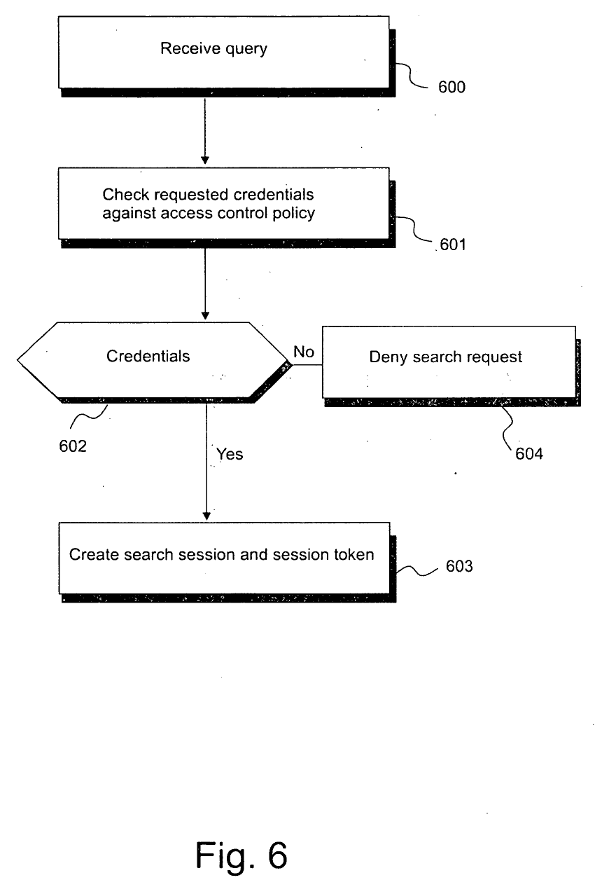

Referring to FIG. 6 herein there is illustrated schematically process steps carried out by the secure hardware device for allowing or denying a search session to commence for a particular user. In process 600, the secure hardware device receives a query having the form of: an index being searched; a key being searched for and; an identity information about a requester originating the query. The information about the requester may include information describing the requester's credentials.

In process 601 the secure hardware device checks the requesters credentials against an access control policy. If the credentials of the requester are in accordance with the access control policy, such that a person having those credentials can access the requested information, then, in process 603, the secure hardware device creates a search token, on which a search session can be based. However, if in process 602, the credentials of the requester are not authorised by the access control policy to access the requested information, then the secure hardware device denies 604 the request for a search based on the query.

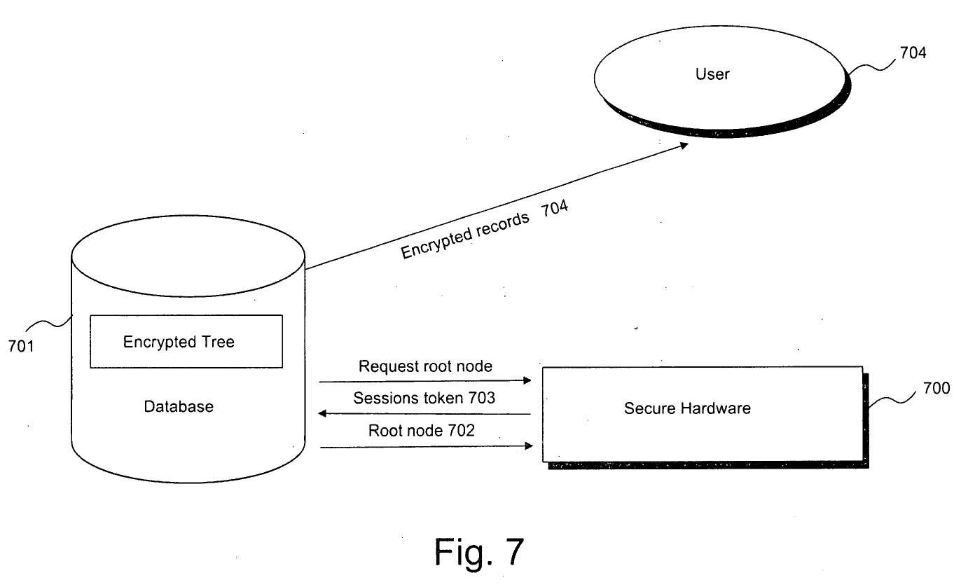

Referring to FIG. 7 herein, the secure hardware device 700 communicates with a server 701, hosting the database, to inform the server which root node is required by the secure hardware device. This is loaded 702 from the server to the secure hardware device along with the session token 703 which refers to the search key stored within the node. A linear search is performed, and the next node pointer is returned until a key is found, or not found as the case may be. A session is linked with a record recovery, that will have separate access control policies, and is returned 704 encrypted to the end user.

More complex searches may involve several indexes where the session is set up over a full set of index searches and results are cached within the secure hardware device, or are encrypted in temporary buffers on the server. The overall results can be encrypted and returned to the user, with encryption based upon a users identification.

Where there is concern that an administrator could start to build up a picture of a set of searches, and which information is in particular nodes, random or extra node recoveries may be inserted to confuse such an analysis.

Security of the system relies on the fact that the unsecure database cannot be searched except through the secure hardware device, because the index tree of the database is encrypted, and can only be decrypted using the secure hardware device. A search query arrives at the secure hardware device from a user. The query is sent to the service operated by the secure hardware device, which if necessary decrypts the query, checks its form, and then runs an index policy to check that the user is allowed to perform that query. The service then issues a session token which is passed back with other tree operations. This token could be a nonce, which would index into a token cache, where information about the session is held within the server. The main data storage system runs most of the search and update algorithms, and fetches the data from the disk with three main functions involved in managing the internals of the tree node being handled the secure hardware device. Access to services provided by the hardware device is managed by the Session State.

However, there is a technical problem in encrypting an entire database, whilst still being able to perform searches of the database.

Securing the Index

Databases can use a variety of indexing mechanisms, but the most common known mechanism for primary keys are b-trees, or sub derivatives of a b-tree. A b-tree is a tree structure where each node has a variable number of keys, and has children between t and 2t−1, where t is the minimization factor. Typically, this factor is set to ensure that nodes have a large branching factor such that the overall block size is roughly the size or a multiple of the underlying storage system. There is much known theory surrounding b-trees and their properties. Many of the algorithms are dependant on the number of disk reads and writes which are related to the tree and typically are 0 (logₜn) algorithms.

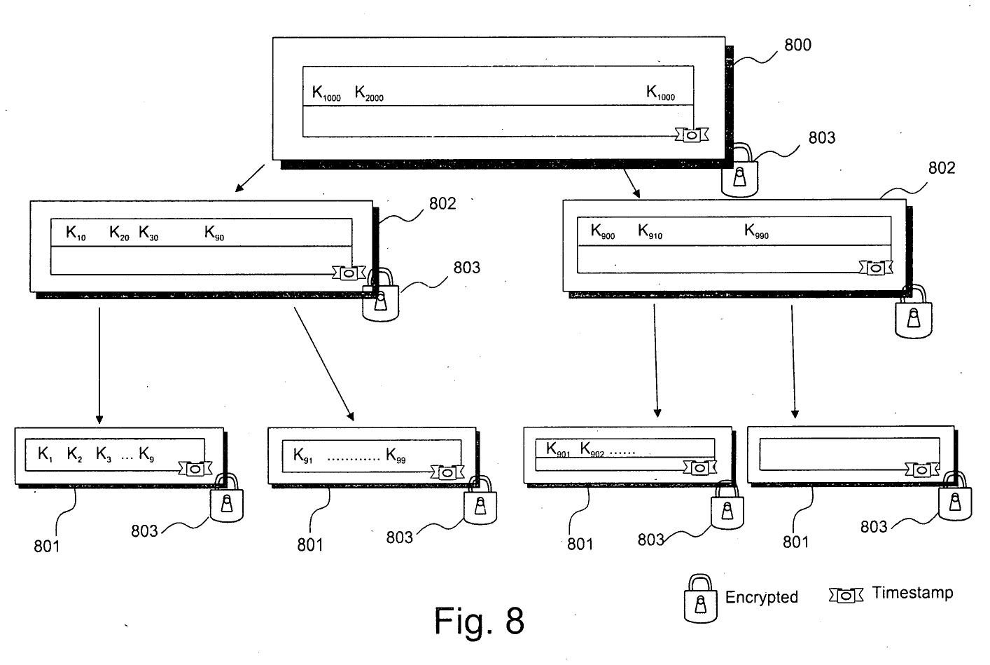

Referring to FIG. 8 herein, there is illustrated schematically a structure of an encrypted index of the database of FIGS. 3 and 7. The index tree comprises a plurality of layers, and has a root and leaf structure in which there is a root node 800 and a plurality of leaf nodes 801 with a plurality of intermediate nodes 802 positioned between the root node 800 and the leaf node 801. Each node is sealed with a MAC and is encrypted, 803.

Encrypting the basic tree nodes leads to more secure indexing. Adding a MAC to the end of the block ensures that the system will detect tampering with the index. Security comes from ensuring that each tree node will only be encrypted within a service, and the manipulation of the blocks is under the control of a policy system operated by the service. The b-tree algorithm is designed to minimize the number of reads and writes. Encrypting and decrypting each block is an additional overhead, but the algorithm remains 0 (logₜn).

Node Structure

Each node which is not a leaf node contains a number of keys ‘K’, and data pointers to data associated with the key each stored in order along with a number of pointers PNT to other nodes within the tree where the number of pointers P=K+1. A first pointer PNT₁ corresponds to all keys less than the first key, and this relationship holds until PNTₖ and Keyₖ; PNTₚ is then appointed a node. With keys larger than Keyₖ each key has an associated data pointer that points to data linked to that key. Each node is formed from three arrays (keys, pointer and data pointers). The Key array is kept sorted and the other arrays are maintained such that their entries correspond to the key array. The node also stores the number of keys and contains a flag to indicate whether the node is a leaf node. Leaf nodes contain the keys and data pointers but have no children nodes (PNTS).

Encrypting the b-tree structure ensures that the key data contained within the structure is protected to stop unauthorised searches and to ensure the users cannot correlate keys between several entries because they point to the same basic data structure. To ensure these goals are achieved all the data in the node structure described above is encrypted, and is only ever decrypted within the secure hardware device. A wrapper around encrypted data describes the data block including its size, the number of elements, its position within the database file (used for encryption) and the encrypted data block. The integrity of the node data is also critical, and as such, each node should have a message authentication code (MAC), or a combined encryption and MAC technique could be used so that the integrity of the tree structure can be validated.

Index Management

Basic algorithms are provided within the secure hardware device for managing the decrypted index tree. These algorithms include algorithms for performing searches, for node creation, node splitting functions, and pointer insert.

Node Splitting

The secure hardware device contains an algorithm for splitting a node of the index tree. In order to split a node, the node is decrypted, and the decrypted node divided into a plurality of nodes. Each of the plurality of nodes, if these are intermediate nodes between a route node and a leaf node, will have a pointer to at least one other node in a lower layer of the b-tree. Each of the plurality of nodes are then re-encrypted and a message authentication code MAC is applied. Any nodes in a layer above the node to be split have their pointers amended, to point to a plurality of split nodes, rather than the original single node pointed to before splitting.

Node Encryption

Each node is individually encrypted using a unique encryption key such that if one node key is broken it is still hard to break into the other nodes pointed to by the decrypted node. For efficiency reasons, a symmetric encryption algorithm is used, where each node key is generated based on the hash of a secret, plus some other information. The secret is assumed to be sharable between several devices within part of a same index service.

Each node key is generated using a hash [node position, policy, secret], where the node position is a pointer value, for example file position. The policy is the name or hash of the index search policy, thus subverting any attempts to read data with alternative policies. The secret is a service secret shared between a set of secure hardware devices used in a search.

Each data block of the index is protected by a MAC. A key used for the MAC can be generated in a similar manner.

Node Decryption

In order to split nodes, insert keys or insert pointers to nodes, or combine two nodes into a larger node, first of all one or more individual nodes of the index tree need to be decrypted. This is done in the secure hardware device using an encryption key that is generated as described with reference to the node encryption above, and is based on a secret that is only available within the secure hardware device (or a set of such devices).

Therefore, any decryption of the node is carried out in the secure hardware device, and therefore any changes to the node can only be carried out by that hardware device.

Pointer Insert

Each node, except the leaf nodes, contain one or more pointers to one or more other nodes within the index. Inserting a new pointer into a node involves decryption of the node using a key which is stored within the secure hardware device, insertion of a new pointer pointing to the new node, and the re-encryption of the node, now containing the new pointer, and time stamping of the node, indicating when the node was last amended. All these operations occur within the secure hardware device, and the new node is sent back to the index stored on the database server.

By handling index manipulation operations inside the secure hardware device, makes it very hard for those persons not entitled to search the index to perform a search of the index. Also, it makes it very hard for authorized or unauthorized users to find out anything from the index structure.

Searching

Referring again to FIG. 8 herein, a basic b-tree search function comprises a single pass function which walks down the tree to find a search key, or determine that the search key is absent. Search algorithms starts at the root of the tree and search through the tree until the key is found, or until it is found not to be in a leaf node. Each node contains a number of keys which is searched in a linear fashion until one greater or equal to the search key is found. Where the search key is found, the corresponding data pointer can be returned. Otherwise the corresponding pointer is followed down the tree. If the algorithm reaches a leaf node without finding the key, then the search fails.

The database system comprises a front door access control to the table index by the b-tree. Once through this, the search proceeds using the simple search algorithm. The search algorithm operations by having the tree node only ever decrypted inside the secure hardware device. This necessitates moving of the access control into the heart of the search.

The search request takes the form of: (the index being searched; the search key; the identity of a requester; credentials of the requester).

This request is initially sent to the session manager in the secure hardware device which applies access control policies associated with the index. The access control policies can range from a simple access control list to more complex policies, for example managing a users name or credentials against a search key. A successful policy check will lead to the issuing of a session token which contains or refers to information about the user, the requested search, and its status. This session token is then used at each block of the b-tree, to avoid the continued re-application of the access policies.

The search request may include a simple search for a key in an index, or it may include a composite search for a range of keys or for several keys. In these cases, the session token may be held over all elements of the query with the results being held as part of the Session State until all the results have been formed.

Where complex queries are formed, the access policies may allow only the complex query rather than the individual parts of the query. In this case the Session State for querying should be combined with access to the entry tables and with the re-encryption of the results for the requester.

The session token is cached within the session manager component of the secure hardware device such that the index search uses that particular piece of secure hardware. The session token may hold more of the session state, but this makes it harder to cache the result. Where multiple secure hardware devices are used, the session information may be communicated between the devices.

The initial search request takes the form:

Search (id requesters_id, SearchSet search_requests)
{

session_tokens = DBEskape.CheckPolicy(requesters_id,

search_requests) foreach (tok in session_tokens)

| | |
|---|---|
| { | // Gives entry set blocks |
| | EntrySet+= SearchKey (tok)’ |

```
  }
  EntrySet+= GetResults(session_tokens):
  }
```

The above algorithm checks the policy for the set of search requests, and then performs each request. The results are collated as each query is carried out, or afterwards as part of a more integrated session process as discussed above. The session token is structured to deal with a set of queries such that each individual query is stored within the session. Each individual element token from session_tokens refers to the overall session and the query number.

The search routine sets up the session and calls the search key function on each element within the search. The session manager may have a table of roots for each of a plurality of indexes, or this could be held centrally.

The tree is traversed using an algorithm as follows:

| EntryPntr Search(Token stok) | |
|---|---|
| { | |
| b = ReadBlock(stok.Index.RootBlockPnt); | |
| do | { |
| | ret = DBEskape.Search(b, stok); |
| | if (ret == null) return ret.pnt ; |
| | b = ReadBlock(ret.b{nt) |

} while(true)
}

The tree traversing algorithm assumes that the information is available from the session token either as the index name, or as the root block position. The traversing algorithm scans through the blocks, passing each block into the session manager, where it is decrypted and searched, and the next block pointer is returned. The tree is traversed until the key is found, or until leaf nodes have been searched. The session manager runs the following function which decrypts and checks the block according to information about the index, policies, and the block position.

```
Search(Block b, Token tok)
{
    bikkey =tok.GetKey(b.Posn) ;// Checks valid token and gets the
    block key if (! B.Decrypt(blkkey);) return null;  // Decrypts and
    checks form for ( l=0; 1<=b.Size&&tok.key > b.key[l] ; l++);
    if ( l<-btok.key== b.key[l] ret.pnt = b.data_pointer[l];
    else if ( b.leaf) return null; // Not found
    else ret.bPnt = b.node_pointer[l]
}
```

Once a valid block has been decrypted and validated, a linear search is completed and the resulting data (Pet.Pnt) or node pointer (Ret.bPnt) is returned. Once a search key is found, the data pointer is either returned, or is added into the Session State for use as part of the results collation process.

The specific embodiments disclosed herein may enhance security of database indexes to a level which makes the embodiments applicable for holding personal data such as for example medical records, or records of confidential business transactions. The embodiments disclosed herein may be used within a trusted audit system for securely indexing audits records.

Specific embodiments described herein may fulfil an aim of ensuring that data in a database is protected to a high level from internal and external attacks in an efficient and low processing cost manner.

1. A database system comprising:
an unsecure database residing on a host computer; said database capable of storing unencrypted data records;
an encrypted index of said data records; and
a secure component capable of manipulating said encrypted index.

2. The database system as claimed in claim 1, wherein said encrypted index comprises:
a plurality of data blocks arranged in a tree structure, each said data block being individually encrypted.

3. The database system as claimed in claim 1, wherein said secure component comprises:
a key manager component for storing a set of keys;
a session manager component for managing a user session of a database;
a policy engine component for applying policies for usage of said database; and
a tamper detection component for detecting tampering with said secure hardware component.

4. The database system as claimed in claim 1, further comprising;
an unsecure data storage area for storing data, said unsecure data storage area being searchable via said encrypted index.

5. The database system as claimed in claim 1, further comprising:
a query manager component, said query manager component operable for obtaining data in response to a user request.

6. The database system as claimed in any one of the preceding claims, wherein said secure component is operable for performing searching of said encrypted index.

7. The database system as claimed in claim 1, wherein said encrypted index comprises a plurality of nodes, each said node comprising data identifying locations of individual data records in an unsecure data storage area; and
said secure component is operable for splitting said nodes.

8. The database system as claimed in claim 1, wherein said encrypted index comprises a plurality of nodes, each said node comprising data identifying locations of individual data records in an unsecure data storage area; and
said secure component is operable for decryption of said nodes.

9. The database system as claimed in claim 1, wherein said encrypted index comprises a plurality of nodes, each said node comprising data identifying locations of individual data records in an unsecure data storage area; and
said secure component is operable for encryption of said nodes.

10. The database system as claimed in claim 1, wherein said encrypted index comprises a plurality of nodes, each said node comprising data identifying locations of individual data records in an unsecure data storage area; and
said secure component is operable for insertion of one or more pointers to said nodes.

11. A database comprising:
an unsecure data storage area, capable of storing a plurality of unencrypted data records; and
an encrypted index for indexing said data records stored in said unsecure data storage area.

12. The database as claimed in claim 11, wherein:
said encrypted index comprises an hierarchical tree structure having a plurality of individually encrypted nodes.

13. The database as claimed in claim 11, wherein,
said encrypted index comprises a plurality of nodes each being associated with a respective an individual message authentication code indicating that the structure of said corresponding node has not been modified.

14. A database system comprising:
a data storage area capable of storing a plurality of data records;
an encrypted index for indexing said plurality of data records stored in said unsecure data storage area;
a secure hardware component capable of managing a database session on behalf of at least one user; and
a query management component capable of performing database query operations within a said search session.

15. A secure hardware component capable of searching an encrypted database index, said component comprising:
a secure tamper proof casing containing:
an index manipulation component, capable of modifying said encrypted database index.

16. The secure hardware component as claimed in claim 15, further comprising:
a key manager component for storing a set of keys.

17. The secure hardware component as claimed in claim 15, further comprising:
a session manager component for managing a user session of said database.

18. The secure hardware component as claimed in claim 15, further comprising:
a policy engine component for applying a policy for usage of a database.

19. The secure hardware component as claimed in claim 15, further comprising:
a tamper detection component for detecting tampering with said secure hardware device.

20. A method of searching an encrypted index by an index manipulating component, said method comprising:
the index manipulating component receiving a search query from a user containing an index to be searched, a key to be searched for and information identifying the user;
the index manipulating component requesting encrypted information in one or more nodes of the index in accordance with the search query;
the index manipulating component decrypting the encrypted information and requesting further encrypted information as necessary to obtain such information as is necessary to answer the search query; and
the index manipulating component causing information necessary to answer the search query to be encrypted with at least a part of the information identifying the user and sent to the user.

21. Means for searching an encrypted index, comprising:
means for receiving a search query from a user, said search query containing an index to be searched, the key to be searched for, and information identifying said user;
means for requesting encrypted information in one or more nodes of the index in accordance with the search query;
means for decrypting the encrypted information and requesting further encrypted information as necessary to obtain such information as is necessary to answer the search query; and
means for encrypting information necessary to answer said search query, said means for encrypting being operable for encrypting said information with at least a part of the information identifying the user.

22. A database system comprising:
a host computer, hosting a database;
an encrypted index comprising a plurality of data blocks arranged in a tree structure, each said data block being individually encrypted; a secure component capable of manipulating said encrypted index, said secure component comprising:
a key manager component for storing a set of keys;
a session manager component for managing a user session of said database;
a policy engine component for applying at least one policy for usage of said database; and
a tamper detection component for detecting tampering of said secure hardware component

23. A secure hardware component capable of searching an encrypted database index, said component comprising:
a secure tamper proof casing containing:
an index manipulation component, capable of searching an encrypted database index;
a key manager component for storing a set of keys;
a session management component for managing a user session for using said database; and
a policy engine component for applying at least one policy concerning using said database.

24. An index manipulation component for manipulating an encrypted index of a database, said index manipulation component comprising:
a computer entity capable of operating in accordance with a set of algorithms, for manipulation of said index;
said set of algorithms comprising:
a node splitting algorithm for splitting at least one node of said index;
a node encryption algorithm for encrypting at least one node of said index;
a node decryption algorithm for decrypting at least one node of said index; and
a pointer insert algorithm for inserting a pointer in said index.

25. An encrypted b-tree index, comprising:
a plurality of nodes, each said node being encrypted, and sealed with a message authentication code (MAC).

26. The index as claimed in claim 25, wherein each said node is formed from:
a key array;
a pointer array;
a set of data pointers.
